(19) United States
(12) Patent Application Publication
(10) Pub. No.: US 2002/0047907 A1
(43) Pub. Date: Apr. 25, 2002

(54) Image processing apparatus and storage medium for storing image processing program

(75) Inventors: Zhe-Hong Chen, Tokyo (JP); Kenichi Ishiga, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 09/939,638

(22) Filed: Aug. 28, 2001

(30) Foreign Application Priority Data
Aug. 30, 2000 (JP) 2000-260730

(51) Int. Cl. H04N 9/04; H04N 3/14

(52) U.S. Cl. 348/222; 348/273

(57) ABSTRACT

Smoothing that uses pieces of color information of at least one color component of a target pixel and of pixels adjacent to the target pixel among a plurality of pixels that form image data is performed selectively for at least one color component of the target pixel. The smoothing is in accordance with correlation between the target pixel and pixels in the vicinity of the target pixel. Since the entire image data is not smoothed uniformly, the smoothing can be performed so as to leave structures inherent to the original image.

### BACKGROUND OF THE INVENTION

1. Field of the Invention

The present invention relates to an image processing device for smoothing image data and to a storage medium in which an image processing program for causing a computer to perform such smoothing is stored.

2. Description of the Related Art

Among electronic cameras are ones that generate color image data by means of an image-capturing sensor in which color filters of plural colors are arranged at prescribed positions. In those electronic cameras, each pixel of the image-capturing sensor outputs color information of only one color component. Therefore, interpolation processing is performed to obtain color information of all color components for each pixel.

In a conventional method of such interpolation processing, spatial similarity between the interpolation target pixel and one of surrounding pixels around it is judged and an interpolated value is calculated by using color information that is output from a surrounding pixel located in a direction with strong similarity. In this method, when the interpolation target pixel has strong similarity in a plurality of directions, it is a common procedure to calculate an interpolated value by equally using pieces of color information of surrounding pixels.

For example, where interpolation processing is performed on image data in which the value of color information varies periodically at intervals each being equal to the one pixel pitch of the image-capturing sensor and each pixel has approximately the same similarity in a plurality of directions as shown in FIG. 10(1), a green interpolated value G′r [i, j] of a pixel that has coordinates [i, j] and outputs R (red) color information is calculated as follows:

G′r[i, j]=(G[i, j−1]+G[i, j+1]+G[i−1, j]+G [i+1, j])/4 +(4·R[i, j]−R[i, j−2]−R[i, j+2]−R[i−2, j]−R[i+2, j])/8 =(200+200+100+100)/4+(4·150−150−150−150 −150)/8 =150

Green interpolated values of other pixels are calculated in similar manners. As a result, as shown in FIG. 10(2), pieces of color information on green color component that are obtained by the interpolation processing show a checkerboard pattern that varies at intervals each being equal to the one pixel pitch of the image-capturing sensor.

Incidentally, color image data of the kind shown in FIG. 10(1) is generated not only when an object image having a high-density checkerboard pattern is captured but also when an object image having a pattern of vertical or horizontal stripes that are arranged at intervals each being equal to the one pixel pitch. It is known that even in the case where an object image having no variations in chrominance is captured, color image data having a high-density checkerboard pattern may be generated due to a gain difference between odd-numbered lines and even-numbered lines of the image-capturing sensor and a wavelength dependence of the depth of penetration of light into the image-capturing sensor.

That is, an original image of color image data as shown in FIG. 10(1) does not necessarily have a high-density checkerboard pattern. A periodic variation of color information on green color component as shown in FIG. 10(2) appears as noise in an image obtained by the interpolation processing and may possibly deteriorate the image quality to a large extent.

Where an image including such noise is stored after being compressed (according to JPEG or the like), the compression efficiency is lowered.

To solve the above problems, in electronic cameras, smoothing is performed to remove a high-density checkerboard pattern from color image data.

However, in the conventional smoothing, the entire color image data is smoothed uniformly. This results in fear that inconsistency may occur in the structures of portions where the chrominance or luminance varies finely and the resolution of the image decreases there. Such a decrease in resolution may occur in monochromatic image data as well as in color image data.

U.S. Pat. No. 5,596,367 discloses a technique in which to make smooth flat portions of color image data that has been subjected to interpolation processing, smoothing is performed on the pixels that belong to the flat portions. However, this technique cannot remove high-density checkerboard patterns as described above nor isolated luminescent spots. Therefore, this technique cannot sufficiently prevent the above-described problems of deterioration in image quality and reduction in compression efficiency.

In the technique disclosed in U.S. Pat. No. 5,596,367, the smoothing is performed by using color information of not only the pixels located in a local area to which the pixel as a subject of smoothing belongs but also pixels around the local area. This results in a possibility that inconsistency occurs in the structure of the local area.

Further, in the technique disclosed in U.S. Pat. No. 5,596,367, the smoothing can be performed only after completion of the interpolation processing; that is, the interpolation processing and the smoothing cannot be performed in parallel. Therefore, very long time is taken from a start of interpolation processing to an end of smoothing.

Still further, in the technique disclosed in U.S. Pat. No. 5,596,367, it is necessary to hold classifiers indicating feature classification results for respective pixels until completion of interpolation processing and smoothing. A large amount of memory is occupied during that course.

### SUMMARY OF THE INVENTION

An object of the present invention is to perform smoothing while leaving structures inherent to an image.

Another object of the invention is to quickly perform smoothing that is accompanied by interpolation.

According to the invention, smoothing that uses pieces of color information of at least one color component of a target pixel and of pixels adjacent to the target pixel is performed selectively for at least one color component of the target pixel, in which the smoothing is done in accordance with correlation between the color information of the target pixel and pieces of color information of pixels in the vicinity of the target pixel.

Since the entire image data is not smoothed uniformly, the smoothing that is performed in the above-described manner can be performed so as to leave structures inherent to the original image. Further, since the smoothing is performed by using pieces of color information of a color component of a pixel as a subject of the smoothing and of pixels adjacent to the target pixel, a desired smoothing effect can be obtained through calculation using a small number of pixels in a local area.

According to another aspect of the invention, the smoothing is performed parallel with interpolation. The smoothing that is performed in this manner can be performed quickly though it is accompanied by the interpolation.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a functional block diagram of an electronic camera;

FIGS. 2(1) and 2(2) are charts showing arrangements of color components of image data in first and second embodiments;

FIG. 3 is a flowchart showing an operation of an image processor according to the first embodiment;

FIGS. 4(1) and 4(2) are charts illustrating manners of weighted addition on similarity components;

FIG. 5 is a chart showing the positions of pieces of color information that are used in calculating a green interpolated value;

FIG. 6 is a chart showing a relationship between the values of (HV[i, j], DN[i, j]) and the direction in which the similarity is high;

FIG. 7 is a flowchart showing an operation of an image processor that is similar to the image processor according to the first embodiment;

FIG. 8 is a flowchart showing an operation of an image processor according to a second embodiment;

FIG. 9 is a flowchart showing an operation of an image processor according to a third embodiment; and

FIGS. 10(1) and 10(2) are charts showing an example of values of color information.

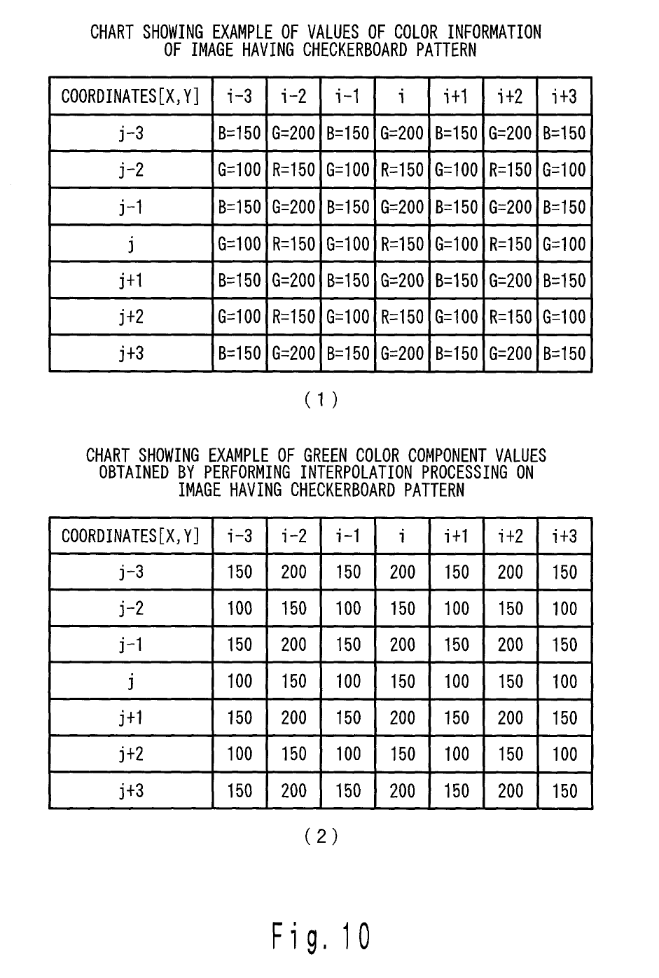

### DESCRIPTION OF THE PREFERRED EMBODIMENTS

Embodiments of the present invention will be hereinafter described with reference to the accompanying drawings.

First to third embodiments are directed to an electronic camera that is provided with a function of image processing that is performed by an image processing device according to the invention.

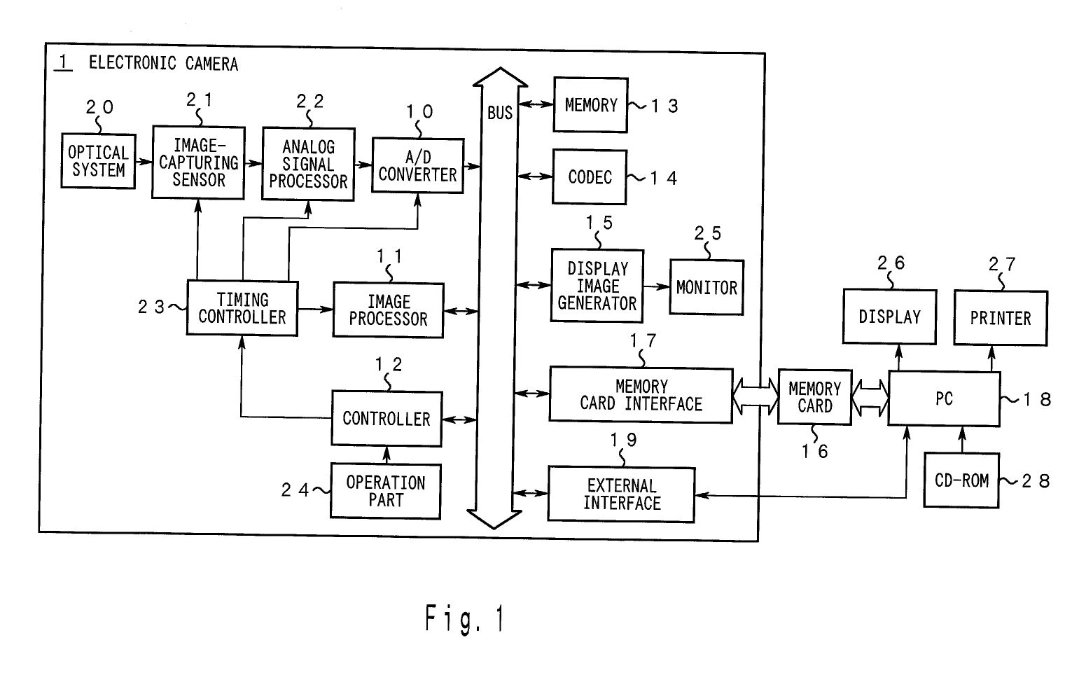

FIG. 1 is a functional block diagram showing an electronic camera corresponding to the first to third embodiments.

As shown in FIG. 1, an electronic camera 1 is provided with an A/D converter 10, an image processor (e.g., a one-chip microprocessor dedicated to image processing) 11, a controller 12, a memory 13, a coder/decoder 14, and a display image generator 15 as well as a memory card interface 17 for interfacing with a memory card (card-shaped removable memory) 16 and an external interface 19 for interfacing with an external device such as a PC (personal computer) 18 via a prescribed cable or a radio channel. The above devices are connected to each other via a bus.

The electronic camera 1 is also provided with an optical system 20, an image-capturing sensor 21, an analog signal processor 22, and a timing controller 23. An optical image is formed on the image-capturing sensor 21 via the optical system 20. The output of the image-capturing sensor 21 is connected to the analog signal processor 22. The output of the analog signal processor 22 is connected to the A/D converter 10. The output of the controller 12 is connected to the timing controller 23. The outputs of the timing controller 23 are connected to the image-capturing sensor 21, the analog signal processor 22, the A/D converter 10, and the image processor 11.

Further, the electronic camera 1 is provided with a monitor 25 and an operation part 24 that corresponds to a release button, a mode switching selection button, etc. The output of the operation part 24 is connected to the controller 12. The output of the display image generator 15 is connected to the monitor 25.

A display 26, a printer 27, etc. are connected to the PC 18. It is assumed that an application program stored in a CD-ROM 28 is installed in the PC 18 in advance. The PC 18 is provided with a CPU, a memory, and a hard disk (all not shown) as well as a memory card interface (not shown) for interfacing with the memory card 16 and an external interface (not shown) for interfacing with an external device such as the electronic camera 1 via a prescribed cable or a radio channel.

In the electronic camera 1 having the configuration of FIG. 1, when an operator selects a shooting mode and depresses the release button by manipulating the operation part 24, the controller 12 performs timing controls for the image-capturing sensor 21, the analog signal processor 22, and the A/D converter 10 via the timing controller 23. The image-capturing sensor 21 generates an image signal corresponding to an optical image. The image signal is subjected to prescribed signal processing in the analog signal processor 22, digitized in the A/D converter 10, and supplied to the image processor 11 as image data. The image processor 11 performs, on the image data, prescribed interpolation processing and smoothing processing (both described later) as well as such image processing as γ correction and edge enhancement. The image data that has been subjected to the image processing is subjected to prescribed compression processing in the coder/decoder 14 when necessary and then written to the memory card 16 via the memory card interface 17.

The image data that has been subjected to the image processing may be written to the memory card 16 without being subjected to compression processing or may be supplied to the PC 18 via the external interface 19 after being converted into data according to a calorimetric system that is employed by the display 26 or the printer 27 of the PC 18 side.

When a reproduction mode is selected by an operator through the operation part 24, image data stored in the memory card 16 is read out via the memory card interface 17, subjected to decompression processing in the coder/decoder 12, and displayed on the monitor 25 via the display image generator 15.

Rather than displayed on the monitor 25, the image data that has been subjected to the decompression processing may be supplied to the PC 18 via the external interface 19 after being converted into data according to a calorimetric system that is employed by the display 26 or the printer 27 of the PC 18 side.

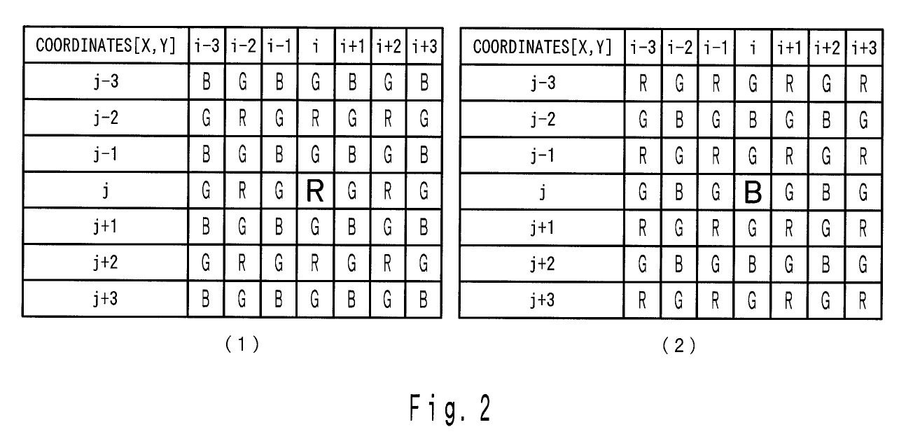

FIGS. 2(1) and 2(2) are charts showing arrangements of color components of image data in first and second embodiments.

In FIGS. 2(1) and 2(2), the kinds of color components are represented by R, G, and B and the positions of pixels where various color components exist are indicated by the values of coordinates [X, Y]. If the interpolation target pixel has coordinates [i,j], each of FIGS. 2(1) and 2(2) shows an arrangement of 7×7 pixels that are centered by the interpolation target pixel. FIG. 2(1) shows the arrangement in which the interpolation target pixel is a pixel where a red color component exists. FIG. 2(2) shows the arrangement in which the interpolation target pixel is a pixel where a blue color component exists.

In the first and second embodiments, the image processor 11 performs interpolation processing (hereinafter referred to as “G interpolation processing”) for interpolating green interpolated values at pixels that miss a green color component and performs smoothing processing on surrounding pixels around the pixels that miss a green color component, and then performs interpolation processing for interpolating red interpolated values and blue interpolated values at pixels that miss a red color component or a blue color component. However, the interpolation processing for interpolating red interpolated values and blue interpolated values can be performed in the same manner as in the conventional cases and hence will not be described.

In the first and second embodiments, to simplify the description, the coordinates of the interpolation target pixel in G interpolation processing are assumed to be [i, j]. And the color information of the interpolation target pixel is denoted by Z[i, j] where R in FIG. 2(1) or B in FIG. 2(2) is replaced by Z because a green interpolated value can be calculated in a manner irrelevant to the kind of color component (red or blue) of the interpolation target pixel. The color information of other pixels is expressed in a similar manner.

In the first to third embodiments, a result of G interpolation processing or smoothing processing is set in G′[X, Y]. It is assumed that color component on the green color component GP[X, Y] is set as an initial value for G′[X, Y] corresponding to a pixel in which color information on green color component exists.

Embodiment 1

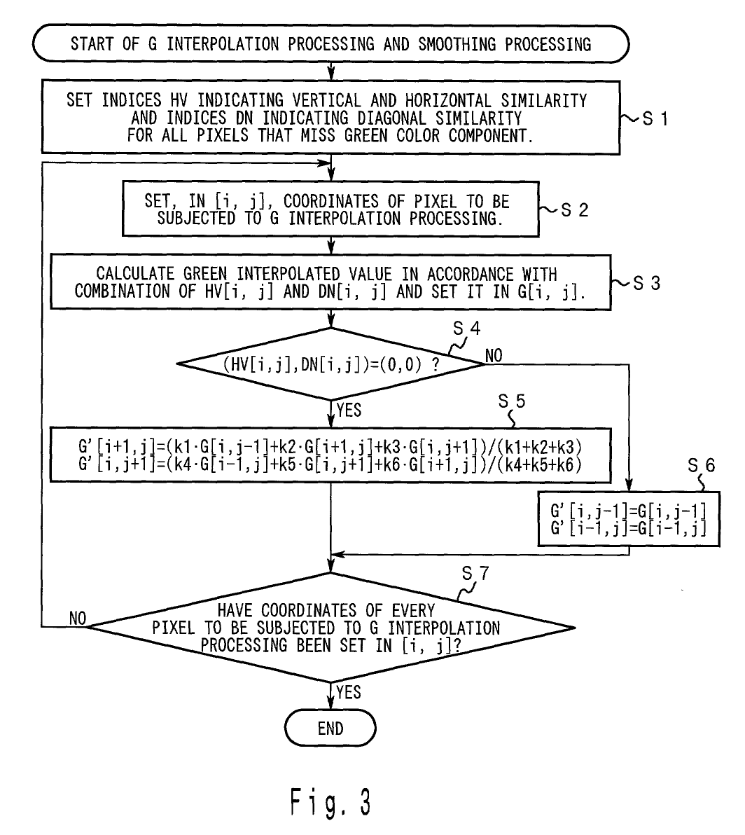

FIG. 3 is a flowchart showing part of the operation of the image processor 11 according to the first embodiment, specifically, G interpolation processing and smoothing processing.

The operation of the first embodiment will be described below. In the following, the G interpolation processing and the smoothing processing of the image processor 11 will be described with reference to FIG. 3 and the other part of the operation will not be described. The first embodiment corresponds to claims 1, 2, 5-10, 12, and 13.

First, the image processor 11 calculates similarity degrees in the vertical direction and the horizontal direction for all pixels that miss a green color component and sets indices HV indicating a similarity in the vertical and horizontal directions (hereinafter referred to as “vertical and horizontal similarity”). Further, the image processor 11 calculates similarity degrees in the diagonal directions and sets indices DN indicating a similarity in the diagonal directions (hereinafter referred to as “diagonal similarity”) (step S1 in FIG. 3).

In the first embodiment, it is assumed that “1” is set in the index HV[i, j] for a pixel having a higher similarity in the vertical direction than in the horizontal direction, “−1” is set in the index HV[i, j] for a pixel having a higher similarity in the horizontal direction than in the vertical direction, and “0” is set in the index HV[i, j] for a pixel in which the similarity in the vertical direction and that in the horizontal direction have no substantial difference. A value “1” is set in the index DN[i, j] for a pixel having a higher similarity in the diagonal 45° direction than in the diagonal 135° direction, “−1” is set in the index DN[i, j] for a pixel having a higher similarity in the diagonal 135° direction than in the diagonal 45° direction, and “0”, is set in the index DN[i, j] for a pixel in which the degrees of similarity in the diagonal directions have no substantial difference.

For example, the processing of setting indices HV and DN for all pixels that miss a green color component can be realized by repeatedly performing the following processing while sequentially setting, in [i, j], coordinates of pixels that miss a green color component.

First, the image processor 11 calculates plural kinds of similarity components in the vertical direction and the horizontal direction that are defined by the following Equations 10-21:

GG similarity component in vertical direction:

Cv1[i, j]=|G[i, j−1]−G[i, j+1]| (10)

GG similarity component in horizontal direction:

Ch1[i, j]=|G[i−1, j]−G[i+1, j]| (11)

BB (RR) similarity component in vertical direction:

Cv2[i, j]=(|Z[i−1, j−1]−Z[i−1, j+1]|+|Z[i+1, j−1]−Z[i+1, j+1]|)/2 (12)

BB (RR) similarity component in horizontal direction:

Ch2[i, j]=(|Z[i−1, j−1]−Z[i+1, j−1]|+|Z[i−1, j+1]−Z[i+1, j+1]|)/2 (13)

RR (BB) similarity component in vertical direction:

Cv3[i, j]=(|Z[i, j−2]−Z[i, j]|+|Z[i, j+2]−Z[i, j]|)/2 (14)

RR (BB) similarity component in horizontal direction:

Ch3[i, j]=(|Z[i−2, j]−Z[i, j]|+|Z[i+2, j]−Z[i, j]|)/2 (15)

GR (GB) similarity component in vertical direction:

Cv4[i, j]=(|G[i, j−1]−Z[i, j]|+|Z[i, j+1]−G[i, j]|)/2 (16)

GR (GB) similarity component in horizontal direction:

Ch4[i, j]=(|G[i−1, j]−Z[i, j]|+|G[i+1, j]−Z[i, j]|)/2 (17)

BG (RG) similarity component in vertical direction:

Cv5[i, j]=(|Z[i−1, j−1]−G[i−1, j]|+|Z[i−1, j+1]−G[i−1, j]|+|Z[i+1, j−1]−G[i+1, j]|+|Z[i+1, j+1]−G[i+1, j]|)/4 (18)

BG (RG) similarity component in horizontal direction:

Ch5[i, j]=(|Z[i−1, j−1]−G[i, j−1]|+|Z[i−1, j+1]−G[i, j+1]|+|Z[i+1, j−1]−G[i, j−1]|+|Z[i+1, j+1]−G[i, j+1]|)/4 (19)

Luminance similarity component in vertical direction:

Cv6[i,j]=(|Y[i, j−1]−Y[i, j]|+|Y[i, j+1]−Y[i, j]|)/2 (20)

Luminance similarity component in horizontal direction:

Ch6[i,j]=(|Y[i−1, j]−Y[i, j]|+|Y[i+1, j]−Y[i, j]|)/2 (21)

In Equations (20) and (21), Y[i, j] is a value that is calculated according to

Y[i, j]={4·A[i, j]+2(A[i, j−1]+A[i, j+1]+A[i−1, j]+A[i+1, j])+A[i−1, j−1]+A[i−1, j+1]+A[i+1, j−1]+A[i+1, j+1]}/16 (22)

and corresponds to luminance that is generated by filtering processing that averages pieces of color information of surrounding pixels at a ratio of R:G:B=1:2:1. A[i, j] represents arbitrary color information on a Bayer array and has a G value or a Z value depending on the location.

In Equations (16)-(19), each term between modulus bars consists of pieces of color information of two pixels adjacent to each other and indicates a gradient between the two pixels adjacent to each other in contrast to a Laplacian second-order that is used for calculation of an ordinary similarity degree. Therefore, the similarity components that are calculated according to Equations (16)-(19) have a function that enables judgment of a similarity in a fine structure such as a checkerboard pattern that varies on a pixel pitch basis.

However, since such similarity components are calculated in such a manner that a difference in chrominance is disregarded, they are very difficult to handle. The strength of similarity may be judged erroneously when they are handled improperly. In view of this, in the following, to calculate similarity degrees that enable highly accurate similarity judgment, weighted addition is performed, for each of the vertical direction and the horizontal direction, on the similarity components calculated according to Equations (16)-(19) (similarity components calculated by using pieces of color information of different colors), the similarity components calculated according to Equations (10)-(15) (similarity components calculated by using pieces of color information of the same color), and the similarity components calculated according to Equations (20) and (21) (similarity components calculated by using luminance values).

That is, the image processor 11 performs, for each of the vertical direction and the horizontal direction, weighted addition on plural kinds of similarity components using weighting coefficients a1-a6 according to the following Equations (23) and (24):

$$\begin{matrix}Cv 0 [ i , j ] = ( a1 \cdot Cv [ i , j ] + a2 \cdot Cv2 [ i , j ] + a3 \cdot Cv3 [ i , j ] + a4 \cdot Cv4 [ i , j ] + a5 \cdot Cv5 [ i , j ] + a6 \cdot Cv6 [ i , j ] ) / ( a1 + a2 + a3 + a4 + a5 + a6 ) & ( 23 ) \\ Ch 0 [ i , j ] = ( a1 \cdot Ch [ i , j ] + a2 \cdot Ch2 [ i , j ] + a3 \cdot Ch3 [ i , j ] + a4 \cdot Ch4 [ i , j ] + a5 \cdot Ch5 [ i , j ] + a6 \cdot Ch6 [ i , j ] ) / ( a1 + a2 + a3 + a4 + a5 + a6 ) & ( 24 )\end{matrix}$$

An example of the ratio among the weighting coefficients a1-a6 in Equations (23) and (24) is a1:a2:a3:a4:a5:a6=2:1:1:4:4:12.

The similarity components Cv0[i, j] and Ch0[i,j] that are calculated according to Equations (23) and (24) can be used, as they are, as a similarity degree in the vertical direction and a similarity degree in the horizontal direction, respectively, of a pixel that misses a green color component. However, other methods will be described below in which a similarity degree in the vertical direction and a similarity degree in the horizontal direction are calculated by performing, for each of the vertical direction and the horizontal direction, calculation of plural kinds of similarity components and weighted addition thereon for not only each pixel that misses a green color component but also its surrounding pixels and performing, for each direction, weighted addition on values obtained by the above weighted addition.

Specifically, the image processor 11 calculates a similarity degree Cv[i, j] in the vertical direction and a similarity degree Ch[i, j] in the horizontal direction of a pixel that misses a green color component by performing weighted addition on results of weighted addition on similarity components of the pixel that misses a green color component and its surrounding pixels (e.g., Cv0[i, j], Cv0[i−1, j−1], Cv0[i−1, j+1], Cv0[i+1, j−1], and Cv0[i+1, j+1]) by the following method-1 or method-2.

$$\begin{matrix}⟨ Method \text{-} 1 ⟩ \\ Cv [ i , j ] = ( 4 \cdot Cv 0 [ i , j ] + Cv 0 [ i - 1 , j - 1 ] + Cv0 [ i - 1 , j + 1 ] + Cv0 [ i + 1 , j - 1 ] + Cv0 [ i + 1 , j + 1 ] ) / 8 & ( 25 ) \\ Ch [ i , j ] = ( 4 \cdot Ch 0 [ i , j ] + Ch 0 [ i - 1 , j - 1 ] + Ch0 [ i - 1 , j + 1 ] + Ch0 [ i + 1 , j - 1 ] + Ch0 [ i + 1 , j + 1 ] ) / 8 & ( 26 ) \\ ⟨ Method \text{-} 2 ⟩ \\ Cv [ i , j ] = \{ 4 \cdot Cv0 [ i , j ] + 2 \cdot ( Cv0 [ i - 1 , j - 1 ] + Cv0 [ i + 1 , j - 1 ] + Cv0 [ i - 1 , j + 1 ] + Cv0 [ i + 1 , j + 1 ] ) + Cv0 [ i , j - 2 ] + Cv0 [ i , j + 2 ] + Cv0 [ i - 2 , j ] + Cv0 [ i + 2 , j ] \} / 16 & ( 27 ) \\ Ch [ i , j ] = \{ 4 \cdot Ch0 [ i , j ] + 2 \cdot ( Ch0 [ i - 1 , j - 1 ] + Ch0 [ i + 1 , j - 1 ] + Ch0 [ i - 1 , j + 1 ] + Ch0 [ i + 1 , j + 1 ] ) + Ch0 [ i , j - 2 ] + Ch0 [ i , j + 2 ] + Ch0 [ i - 2 , j ] + Ch0 [ i + 2 , j ] \} / 16 & ( 28 )\end{matrix}$$

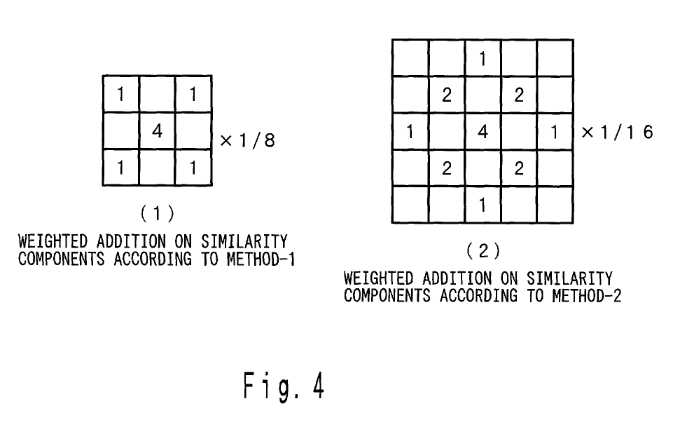

The method-1 corresponds to a case where weighted addition is performed on similarity components of a pixel that misses a green color component and its surrounding pixels in a manner shown in FIG. 4(1), and the method-2 corresponds to a case where weighted addition is performed on similarity components of a pixel that misses a green color component and its surrounding pixels in a manner shown in FIG. 4(2).

Therefore, the similarity degree Cv[i, j] in the vertical direction and the similarity degree Ch[i, j] in the horizontal direction tend to reflect continuity of color information between the interpolation target pixel and pixels in its vicinities. In particular, reflecting pieces of color information of pixels located in a wide area, the similarity degree Cv[i, j] in the vertical direction and the similarity degree Ch[i, j] in the horizontal direction calculated by the method-2 are effective in judging a similarity of, for example, an image having a large chromatic aberration of magnification.

Each of the similarity degree Cv[i, j] in the vertical direction and the similarity degree Ch[i, j] in the horizontal direction indicates that the similarity is higher when it has a smaller value.

After calculating the similarity degree Cv[i, j] in the vertical direction and the similarity degree Ch[i, j] in the horizontal direction in the above-described manner, when conditions

|Cv[i, j]−Ch[i, j]|>T1, and Cv[i, j]<Ch[i, j]

are satisfied for an arbitrary threshold value T1, the image processor 11 sets “1” in the index HV[i, j] with a judgment that the similarity in the vertical direction is higher than in the horizontal direction. If conditions

Cv[i, j]−Ch[i, j]>T1, and Cv[i, j]>Ch[i, j]

are satisfied, the image processor 11 sets “−1” in the index HV[i, j] with a judgment that the similarity in the horizontal direction is higher than in the vertical direction. If a condition

|Cv[i, j]−Ch[i, j]|≦T1

is satisfied, the image processor 11 sets “0” in the index HV[i, j] with a judgment that the similarity in the vertical direction and that in the horizontal direction have no substantial difference. “The similarity in the vertical direction and that in the horizontal direction have no substantial difference” corresponds to a case that both degrees of similarity are high, both degrees of similarity are low, or the two degrees of similarity are approximately the same, and means that it is highly probable that the pixel concerned belongs to a flat portion, an isolated luminescent spot, or a high-density checkerboard pattern.

The threshold value T1 serves to prevent an event that an erroneous judgment that one similarity is higher than the other is made due to influence of noise when the difference between the similarity degree Cv[i, j] in the vertical direction and the similarity degree Ch[i, j] in the horizontal direction is small. Therefore, the accuracy of the judgment of the vertical and horizontal similarity for an image having large noise can be increased.

Then, the image processor 11 calculates plural kinds of similarity components in the diagonal 45° direction and the diagonal 135° direction that are defined by the following Equations (29)-(36):

GG similarity component in diagonal 45° direction:

C45_{—}1[i, j]=(|G[i, j−1]−G[i−1, j]|+|G[i+1, j]−G[i, j+1]|)/2 (29)

GG similarity component in diagonal 135° direction:

$$C135\_ 1 [ i , j ] = ( \vert G [ i , j - 1 ] - G [ i + 1 , j ] \vert + \vert G [ i - 1 , j ] - G [ i , j + 1 ] \vert ) / 2 \qquad ( 30 )$$

BB (RR) similarity component in diagonal 45° direction:

C45_{—}2[i, j]=(|Z[i+1, j−1]−Z[i−1, j+1]| (31)

BB (RR) similarity component in diagonal 135° direction:

Ch135_{—}2[i, j]=(|Z[i−1, j−1]−Z[i+1, j+1] (32)

RR (BB) similarity component in diagonal 45° direction:

$$C45\_ 3 [ i , j ] = ( \vert Z [ i + 2 , j - 2 ] - Z [ i , j ] \vert + \vert Z [ i - 2 , j + 2 ] - Z [ i , j ] \vert ) / 2 \qquad ( 33 )$$

RR (BB) similarity component in diagonal 135° direction:

$$C135\_ 3 [ i , j ] = ( \vert Z [ i - 2 , j - 2 ] - Z [ i , j ] \vert + \vert Z [ i + 2 , j + 2 ] - Z [ i , j ] \vert ) / 2 \qquad ( 34 )$$

BR (RB) similarity component in diagonal 45° direction.

$$C45\_ 4 [ i , j ] = ( \vert Z [ i + 1 , j - 1 ] - Z [ i , j ] \vert + \vert Z [ i - 1 , j + 1 ] - Z [ i , j ] \vert ) / 2 \qquad ( 35 )$$

BR (RB) similarity component in diagonal 135° direction:

$$C135\_ 4 [ i , j ] = ( \vert Z [ i - 1 , j - 1 ] - Z [ i , j ] \vert + \vert Z [ i + 1 , j + 1 ] - Z [ i , j ] \vert ) / 2 \qquad ( 36 )$$

Then, the image processor 11 performs, for each direction, weighted addition on plural kinds of similarity components using weighting coefficients b1-b4 according to the following Equations (37) and (38):

$$\begin{matrix}C45\_ 0 [ i , j ] = ( b1 \cdot C45\_ [ i , j ] + b2 \cdot C45\_ 2 [ i , j ] + b3 \cdot C45\_ 3 [ i , j ] + b4 \cdot C45\_ 4 [ i , j ] ) / ( b1 + b2 + b3 + b4 ) & ( 37 ) \\ C135\_ 0 [ i , j ] = ( b1 \cdot C135\_ [ i , j ] + b2 \cdot C135\_ 2 [ i , j ] + b3 \cdot C135\_ 3 [ i , j ] + b4 \cdot C135\_ 4 [ i , j ] ) / ( b1 + b2 + b3 + b4 ) & ( 38 )\end{matrix}$$

An example of the ratio among the weighting coefficients b1-b4 in Equations (37) and (38) is b1:b2:b3:b4=2:1:1:2.

Calculation of plural kinds of similarity components and weighted addition thereon are performed for each of the diagonal 45° direction and the diagonal 135° direction for not only each pixel that misses a green color component but also its surrounding pixels as in the case of the calculation of plural kinds of similarity components and the weighted addition thereon that are performed for each of the vertical direction and the horizontal direction.

Specifically, the image processor 11 calculates a similarity degree Cv[i, j] in the diagonal 45° direction and a similarity degree Ch[i, j] in the diagonal 135° direction of a pixel that misses a green color component by performing weighted addition on results of weighted addition on similarity components of the pixel that misses a green color component and its surrounding pixels (e.g., C45_{—}0[i, j], C45_{—}0[i−1, j−1], C45_{—}0[i−1, j+1], C45_{—}0[i+1, j−1], and C45_{—}0[i+1, j+1]) by the following method-1 or method-2. (Weighted addition is performed on similarity components of a pixel that misses a green color component and its surrounding pixels in a manner shown in FIG. 4(1) or 4(2).)

$$\begin{matrix}⟨ Method \text{-} 1 ⟩ \\ C45 [ i , j ] = ( 4 \cdot C45\_ 0 [ i , j ] + C45\_ 0 [ i - 1 , j - 1 ] + C45\_ 0 [ i + 1 , j - 1 ] + C45\_ 0 [ i - 1 , j + 1 ] + C45\_ 0 [ i + 1 , j + 1 ] ) / 8 & ( 39 ) \\ C135 [ i , j ] = ( 4 \cdot C135\_ 0 [ i , j ] + C135\_ 0 [ i - 1 , j - 1 ] + C135\_ 0 [ i + 1 , j - 1 ] + C135\_ 0 [ i - 1 , j + 1 ] + C135\_ 0 [ i + 1 , j + 1 ] ) / 8 & ( 40 ) \\ ⟨ Method \text{-} 2 ⟩ \\ C45 [ i , j ] = \{ 4 \cdot C45\_ 0 [ i , j ] + 2 \cdot ( C45\_ 0 [ i - 1 , j - 1 ] + C45\_ 0 [ i + 1 , j - 1 ] + C45\_ 0 [ i - 1 , j + 1 ] + C45\_ 0 [ i + 1 , j + 1 ] ) + C45\_ 0 [ i , j - 2 ] + C45\_ 0 [ i , j + 2 ] + C45\_ 0 [ i - 2 , j ] + C45\_ 0 [ i + 2 , j ] \} / 16 & ( 41 ) \\ C135 [ i , j ] = \{ 4 \cdot C135\_ 0 [ i , j ] + 2 \cdot ( C135\_ 0 [ i - 1 , j - 1 ] + C135\_ 0 [ i + 1 , j - 1 ] + C135\_ 0 [ i - 1 , j + 1 ] + C135\_ 0 [ i + 1 , j + 1 ] ) + C135\_ 0 [ i , j - 2 ] + C135\_ 0 [ i , j + 2 ] + C135\_ 0 [ i - 2 , j ] + C135\_ 0 [ i + 2 , j ] \} / 16 & ( 42 )\end{matrix}$$

In the similarity degree C45[i, j] in the diagonal 45° direction and the similarity degree C135[i, j] in the diagonal 135° direction that are calculated in the above-described manner, the weighted addition on plural kinds of similarity components and the weighted addition on the similarity components of a pixel that misses a green color component and its surrounding pixels play the same roles as in the similarity degree Cv[i, j] in the vertical direction and the similarity degree Ch[i, j] in the horizontal direction that were described above. In the first embodiment, each of the similarity degree C45[i, j] in the diagonal 45° direction and the similarity degree C135[i, j] in the diagonal 135° direction indicates that the similarity is higher when it has a smaller value.

After calculating the similarity degree C45v[i, j] in the diagonal 45° direction and the similarity degree C135[i, j] in the diagonal 135° direction in the above-described manner, when conditions

|C45[i, j]−C135[i, j]|>T2, and C45[i, j]<C135[i, j]

are satisfied for an arbitrary threshold value T2, the image processor 11 sets “1” in the index DN[i, j] with a judgment that the similarity in the diagonal 45° direction is higher than in the diagonal 135° direction. If conditions

C45[i, j]−C135[i, j]|>T2, and C45[i, j]>C135[i, j]

are satisfied, the image processor 11 sets “−1” in the index DN[i, j] with a judgment that the similarity in the diagonal 135° direction is higher than in the diagonal 45° direction. If a condition

|C45[i, j]−C135[i, j]|≦T2

is satisfied, the image processor 11 sets “0” in the index DN[i, j] with a judgment that the similarity in the diagonal directions have no substantial difference. “The similarity in the diagonal directions have no substantial difference” corresponds to a case that both degrees of similarity are high, both degrees of similarity are low, or the two degrees of similarity are approximately the same, and means that it is highly probable that the pixel concerned belongs to a flat portion, an isolated luminescent spot, or a high-density checkerboard pattern.

Like the above-described threshold value T1, the threshold value T2 serves to prevent an event that an erroneous judgment that one similarity is higher than the other is made due to influence of noise.

After setting the index HV indicating vertical and horizontal similarity and the index DN indicating diagonal similarity for each pixel that misses a green color component, the image processor 11 sets, in [i, j], the coordinates of the pixel that should be subjected to the G interpolation processing (step S2 in FIG. 3).

Step S2 in FIG. 3 is executed repeatedly. It is assumed that during the repetition the coordinates of pixels that miss a green color component among the pixels from the one located at the top-left corner of an image to the one located at its bottom-right corner are sequentially set in [i, j].

Then, a green interpolated value is calculated in accordance with a combination of the values of the index HV[i, j] indicating vertical and horizontal similarity and the index DN[i, j] indicating diagonal similarity, and it is set in G′[i, j] (step S3 in FIG. 3).

For example, the image processor 11 classifies the pixel having the coordinates [i, j] as one of the following case1 to case9 in accordance with a combination of the values of the index HV[i, j] indicating vertical and horizontal similarity and the index DN[i, j] indicating diagonal similarity:

case1: (HV[i, j], DN[i, j])=(1, 1); the similarity is high in the vertical direction and the diagonal 45° direction.

case2: (HV[i, j], DN[i, j])=(1, 0); the similarity is high in the vertical direction.

case3: (HV[i, j], DN[i, j])=(1, −1); the similarity is high in the vertical direction and the diagonal 135° direction.

case4: (HV[i, j], DN[i, j])=(0, 1); the similarity is high in the diagonal 45° direction.

case5: (HV[i, j], DN[i, j])=(0, 0); the similarity is high in all the directions, the similarity is low in all the directions, or the similarity is approximately the same in all the directions.

case6: (HV[i, j], DN[i, j])=(0, −1); the similarity is high in the diagonal 135° direction.

case7: (HV[i, j], DN[i, j])=(−1, 1); the similarity is high in the horizontal direction and the diagonal 45° direction.

case 8: (HV[i, j], DN[i, j])=(−1, 0); the similarity is high in the horizontal direction.

case9: (HV[i, j], DN[i, j])=(−1, −1); the similarity is high in the horizontal direction and the diagonal 135° direction.

The image processor 11 sets, in G′[i, j], as a green interpolated value, a value that is calculated in the following manner in accordance with the class thus determined:

case1: G′[i, j]=Gv45[i, j]

case2: G′[i, j]=Gv[i, j]

case3: G′[i, j]=Gv135[i, j]

case4: G′[i, j]=(Gv45[i, j]+Gh45[i, j])/2

case5: G′[i, j]=(Gv[i, j]+Gh[i, j])/2

case6: G′[i, j]=(Gv135[i, j]+Gh135[i, j])/2

case7: G′[i, j]=Gh45[i, j]

case8: G′[i, j]=Gh[i, j]

case9: G′[i, j]=Gh135[i, j]

where

$$\begin{matrix}Gv [ i , j ] = ( G [ i , j - 1 ] + G [ i , j + 1 ] ) / 2 + ( 2 \cdot Z [ i , j ] - Z [ i , j - 2 ] - Z [ i , j + 2 ] ) / 8 + ( 2 \cdot G [ i - 1 , j ] - G [ i - 1 , j - 2 ] - G [ i - 1 , j + 2 ] + 2 \cdot G [ i + 1 , j ] - G [ i + 1 , j - 2 ] - G [ i + 1 , j + 2 ] ) / 16 & ( 43 ) \\ Gv45 [ i , j ] = ( G [ i , j - 1 ] + G [ i , j + 1 ] ) / 2 + ( 2 \cdot Z [ i , j ] - Z [ i , j - 2 ] - Z [ i , j + 2 ] ) / 8 + ( 2 \cdot Z [ i - 1 , j + 1 ] - Z [ i - 1 , j - 1 ] - Z [ i - 1 , j + 3 ] + 2 \cdot Z [ i + 1 , j - 1 ] - Z [ i + 1 , j - 3 ] - Z [ i + 1 , j + 1 ] ) / 16 & ( 44 ) \\ Gv135 [ i , j ] = ( G [ i , j - 1 ] + G [ i , j + 1 ] ) / 2 + ( 2 \cdot Z [ i , j ] - Z [ i , j - 2 ] - Z [ i , j + 2 ] ) / 8 + ( 2 \cdot Z [ i - 1 , j - 1 ] - Z [ i - 1 , j - 3 ] - Z [ i - 1 , j + 1 ] + 2 \cdot Z [ i + 1 , j + 1 ] - Z [ i + 1 , j - 1 ] - Z [ i + 1 , j + 3 ] ) / 16 & ( 45 ) \\ Gh [ i , j ] = ( G [ i - 1 , j ] + G [ i + 1 , j ] ) / 2 + ( 2 \cdot Z [ i , j ] - Z [ i - 2 , j ] - Z [ i + 2 , j ] ) / 8 + ( 2 \cdot G [ i , j - 1 ] - G [ i - 2 , j - 1 ] - G [ i + 2 , j - 1 ] + 2 \cdot G [ i , j + 1 ] - G [ i - 2 , j + 1 ] - G [ i + 2 , j + 1 ] ) / 16 & ( 46 ) \\ Gh45 [ i , j ] = ( G [ i - 1 , j ] + G [ i + 1 , j ] ) / 2 + ( 2 \cdot Z [ i , j ] - Z [ i - 2 , j ] - Z [ i + 2 , j ] ) / 8 + ( 2 \cdot Z [ i + 1 , j - 1 ] - Z [ i - 1 , j - 1 ] - Z [ i + 3 , j - 1 ] + 2 \cdot Z [ i - 1 , j + 1 ] - Z [ i - 3 , j + 1 ] - Z [ i + 1 , j + 1 ] ) / 16 & ( 47 ) \\ Gh135 [ i , j ] = ( G [ i - 1 , j ] + G [ i + 1 , j ] ) / 2 + ( 2 \cdot Z [ i , j ] - Z [ i - 2 , j ] - Z [ i + 2 , j ] ) / 8 + ( 2 \cdot Z [ i - 1 , j - 1 ] - Z [ i - 3 , j - 1 ] - Z [ i + 1 , j - 1 ] + 2 \cdot Z [ i + 1 , j + 1 ] - Z [ i - 1 , j + 1 ] - Z [ i + 3 , j + 1 ] ) / 16 & ( 48 )\end{matrix}$$

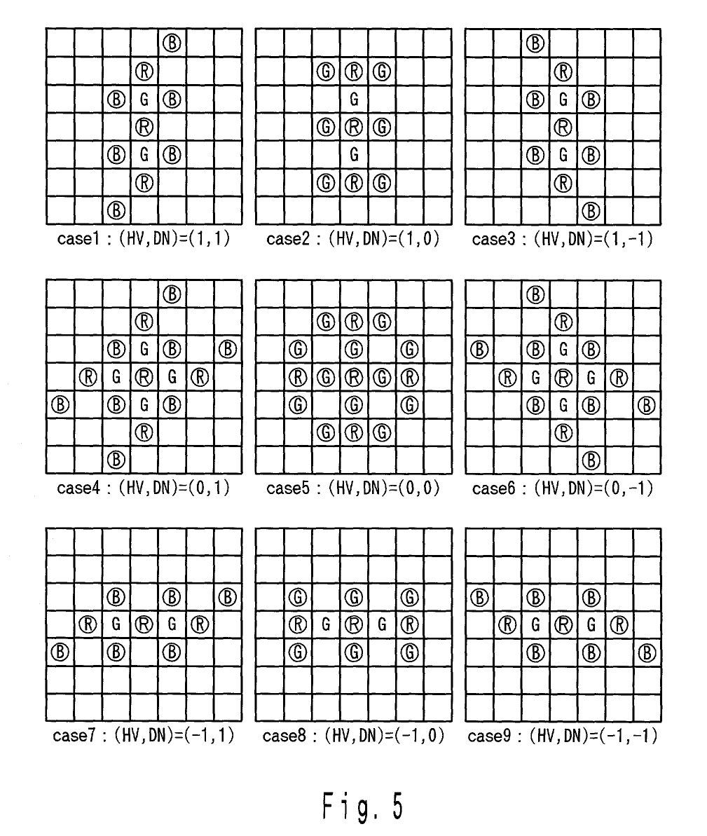

FIG. 5 is a chart showing the positions of pieces of color information that are used in calculating a green interpolated value. In FIG. 5, the pieces of color information of circled pixels are ones that contribute to curvature information of a green interpolated value.

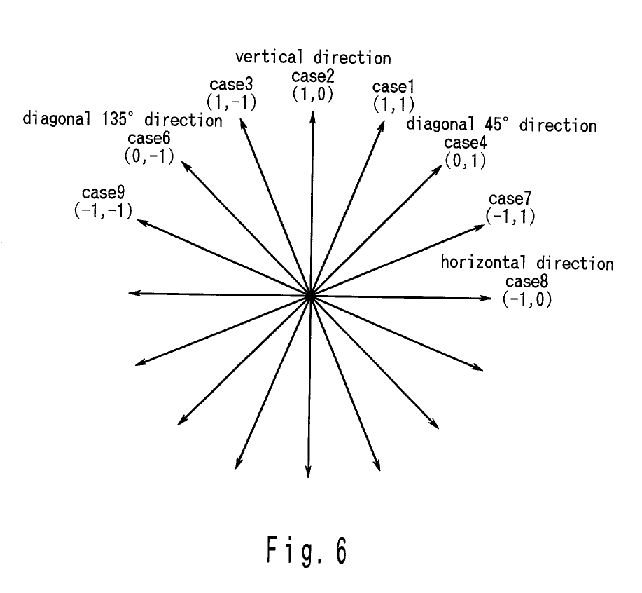

FIG. 6 is a chart showing a relationship between the values of (HV[i, j], DN[i, j]) and the direction in which the similarity is high.

FIG. 6 does not show any direction corresponding to “case5: (HV[i, j], DN[i, j])=(0, 0)”, because case5 corresponds to a case that the similarity is high in all the directions (flat portion), the similarity is low in all the directions (isolated luminescent spot), or the similarity is approximately the same in all the directions (high-density checkerboard pattern). In particular, a high-density checkerboard pattern does not exist in an original image, is visually conspicuous, and deteriorates the image quality as noise.

Therefore, in the first embodiment, a high-density checkerboard pattern is removed by performing smoothing processing in the following manner on surrounding pixels of a pixel that is classified into case5.

First, the image processor 11 judges whether both of the value of the index HV[i, j] showing the vertical and horizontal similarity of the pixel having the coordinates [i, j] (i.e., the pixel for which the interpolated value has been calculated) and the value of the index DN showing the diagonal similarity of the pixel are equal to 0 (i.e., whether the pixel having the coordinates [i, j] has been classified into case5) (step S4 in FIG. 3).

If the values of both indices HV[i, j] and DN[i, j] are 0 (i.e., , the pixel having the coordinates [i, j] has been classified into case5), the image processor 11 calculates G′[i+1, j] according to Equation (49) as a result of smoothing processing on the pixel having coordinates [i+1, j] (i.e., the pixel immediately on the right of the pixel for which the interpolated value has been calculated) and also calculates G′[i, j+1] according to Equation (50) as a result of smoothing processing on the pixel having coordinates [i,j+1] (i.e., the pixel immediately under the pixel for which the interpolated value has been calculated) (step S5 in FIG. 3).

G′[i+1, j]=(k1·G[i, j−1]+k2·G[i+1, j]+k3·G[i, j+1])/(k1+k2+k3) (49)

G′[i, j+1]=(k4·G[i−1, j]+k5·G[i, j+1]+k6·G[i+1, j])/(k4+k5+k6) (50)

The operation of Equation (49) corresponds to replacing the color information on green color component of the pixel having the coordinates [i+1, j] with a value obtained by performing weighted addition on the pieces of color information on green color component of the pixels having coordinates [i, j−1], [i+1, j], and [i, j+], respectively.

The operation of Equation (50) corresponds to replacing the color information on green color component of the pixel having the coordinates [i, j+1] with a value obtained by performing weighted addition on the pieces of color information on green color component of the pixels having coordinates [i−1, j], [i, j+1], and [i+1, j], respectively.

In Equations (49) and (50), the degree of smoothing can be changed by changing the values of k1-k6. For example, setting the values of k1-k6 in such a manner that k1=k3=k4=k6=1 and k2=k5=2 means complete smoothing. To decrease the degree of smoothing, the values of k1-k6 may be set in such a manner that k1=k3=k4=k6=1 and k2=k5=6, for example.

For pixels in the vicinity of a pixel that is not classified into case5, it is not necessary to set, as a result of smoothing processing, a value calculated according to Equation (49) or (50), that is, it is proper to set the color information on green color component as a result of smoothing processing. However, there is a possibility that a value that was calculated according to Equation (49) or (50) in previous processing is set as a result of smoothing for the pixel immediately over or immediately on the left of a pixel that is not classified into case5.

In view of the above, when at least one of the values of the indices HV[i, j] and DN[i, j] is not equal to 0 (i.e., the pixel having the coordinates [i, j] is not classified into case5), the image processor 11 restores the value G′[i, j−1] indicating a result of smoothing processing on the pixel having the coordinates [i, j−1] (i.e., the pixel immediately over the pixel having the coordinates [i, j]) and the value G′[i−1, j] indicating a result of smoothing processing on the pixel having the coordinates [i−1, j] (i.e., the pixel immediately on the left of the pixel having the coordinates [i, j]) to their original pieces of color information on green color component according to Equations (51) and (52) (step S6 in FIG. 3).

G′[i, j−1]=G[i, j−1] (51)

G′[i−1, j]=G[i−1, j] (52)

Then, the image processor 11 judges whether the coordinates of every pixel to be subjected to the G interpolation processing have been set in [i, j] (step S7 in FIG. 3). If there remains a pixel(s) to be subjected to the G interpolation processing whose coordinates have not been set in [i, j], the image processor 11 again executes step S2 and the following steps.

With the above processing, in the first embodiment, green interpolated values and values indicating results of the smoothing processing are set in G′[i, j]'s. That is, the interpolation processing and the smoothing processing are performed parallel.

As described above, in the first embodiment, when a pixel that misses color information on green color component is classified into case5, values obtained by performing weighted addition on pieces of color information on green color component in a local area are set as values indicating results of smoothing processing on pixels immediately on the right of and immediately under the pixel that misses color information on green color component. If a pixel that misses color information on green color component is not classified into case5, the original pieces of color information on green color component of the pixels immediately over and immediately on the left of the pixel that misses color information on green color component are set as values indicating results of smoothing processing on those pixels.

Therefore, in the first embodiment, the pieces of color information in a flat area, an area of an isolated luminescent spot, or an area having a high-density checkerboard pattern are smoothed and hence the smoothing does not impair structures inherent in an image.

In the first embodiment, green interpolated values are calculated and the smoothing processing is performed after indices HV indicating vertical and horizontal similarity and indices DN indicating diagonal similarity have been set for all pixels that miss a green color component. Alternatively, indices HV and DN may be set immediately before a green interpolated value for each interpolation target pixel is calculated.

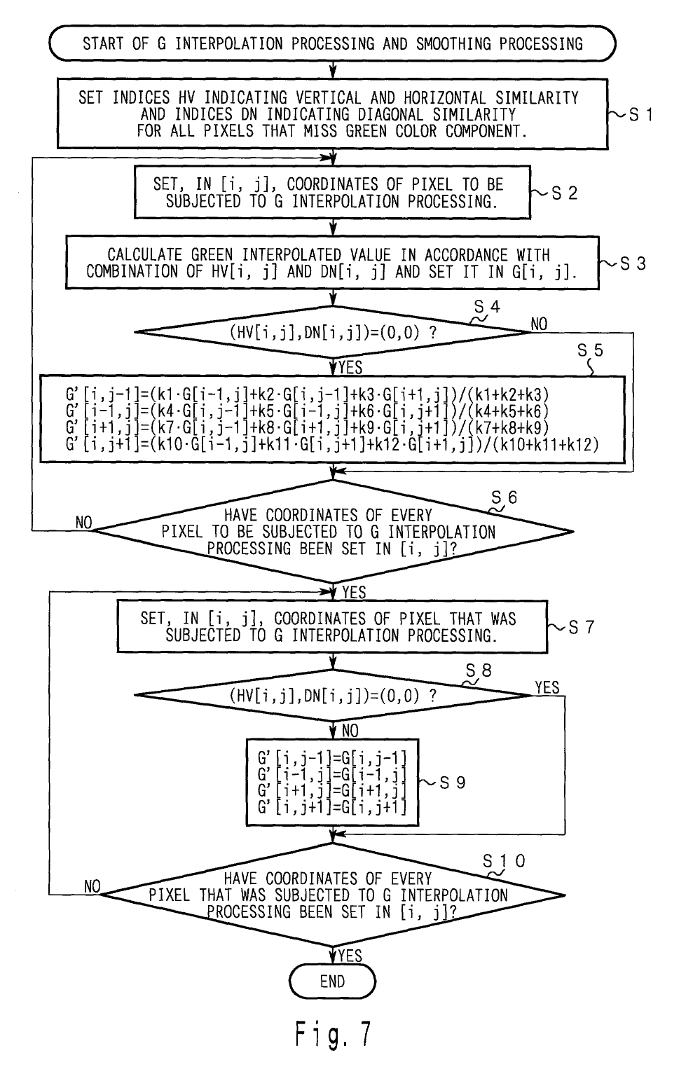

In the first embodiment, the smoothing processing is realized in such a manner that values obtained by performing weighted addition on pieces of color information on green color component in a local area are set for pixels adjacent to a pixel that is classified into case5 (in the first embodiment, only the pixels immediately on the right of and immediately under the pixel that is classified into case5), and that the original pieces of color information on green color component are set for pixels adjacent to a pixel that is not classified into case5 (in the first embodiment, only the pixels immediately over and immediately on the left of the pixel that is not classified into case5). Alternatively, the smoothing processing may be realized in a manner shown in FIG. 7.

In FIG. 7, the image processor 11 calculates a green interpolated value for the pixel as the subject of the G interpolation processing while sequentially setting, in [i, j], the coordinates of pixels to be subjected to the G interpolation processing (step S3 in FIG. 7). If the pixel as the subject of the G interpolation processing is classified into case5 (yes at step S4 in FIG. 7), the image processor 11 sets a value obtained by performing weighted addition on pieces of color information on green color component in a local area as a value indicating a result of smoothing processing on the four pixels adjacent to the target pixel (step 55 in FIG. 7). When the above steps have completed for all pixels to be subjected to the G interpolation processing, the image processor 11 sequentially sets, in [i, j], the coordinates of a pixel that was subjected to the G interpolation processing. If the pixel that was subjected to the G interpolation processing is not classified into case5 (no at step S8 in FIG. 7), the image processor 11 sets the original pieces of color information on green color component as values indicating results of smoothing processing on the four pixels adjacent to the pixel concerned (step S9 in FIG. 7).

Embodiment 2

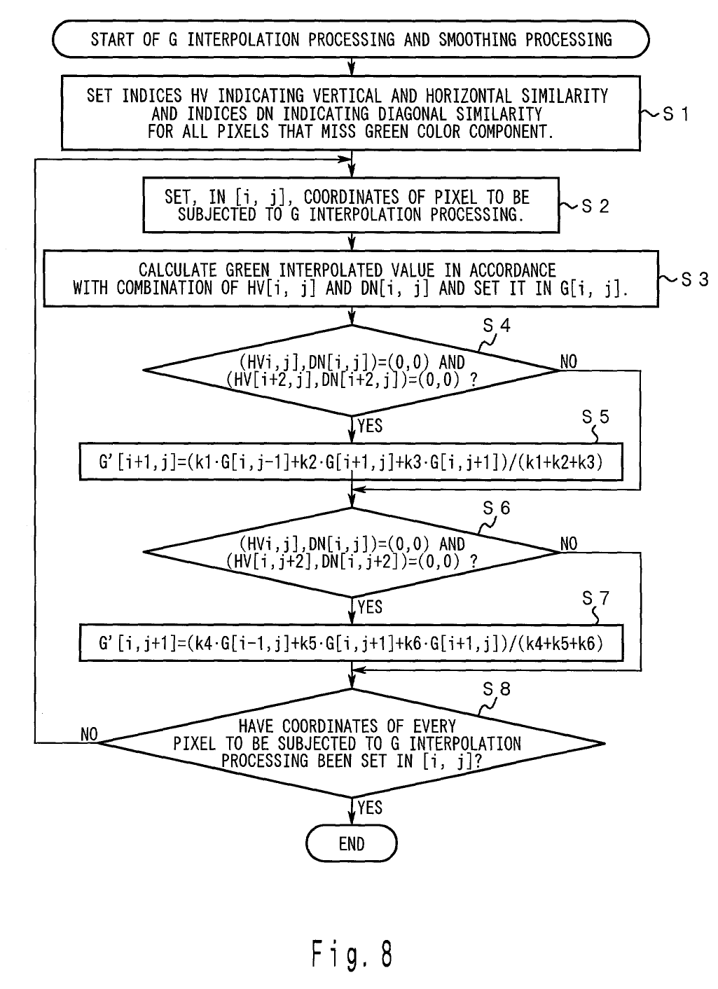

FIG. 8 is a flowchart showing part of the operation of the image processor 11 according to a second embodiment, specifically, G interpolation processing and smoothing processing.

The operation of the second embodiment will be described below. In the following, the G interpolation processing and the smoothing processing of the image processor 11 will be described with reference to FIG. 8 and the other part of the operation will not be described. The second embodiment corresponds to claims 1, 2, 5-8, and 11-13.

First, the image processor 11 calculates similarity degrees in the vertical direction and horizontal direction for all pixels that miss a green color component and sets indices HV indicating vertical and horizontal similarity. Further, the image processor 11 calculates similarity degrees in the diagonal directions and sets indices DN indicating a similarity in the diagonal directions (hereinafter referred to as “diagonal similarity”) (step S1 in FIG. 8).

Then, in the same manners as in the first embodiment, the image processor 11 sets, in [i, j], the coordinates of a pixel to be subjected to the G interpolation processing (step S2 in FIG. 8) and calculates a green interpolated value G[i, j] in accordance with a combination of the index HV[i, j] indicating vertical and horizontal similarity and the index DN[i, j] indicating diagonal similarity (step S3 in FIG. 8).

Then, the image processor 11 judges whether the values of the indices HV[i, j] and DV[i, j] indicating the vertical and horizontal similarity and the diagonal similarity, respectively, of the pixel having the coordinates [i, j] and the values of the indices HV[i+2, j] and DV[i+2, j] indicating vertical and horizontal similarity and diagonal similarity, respectively, of the pixel having the coordinates [i+2, j] satisfy the following conditions-1 (step S4 in FIG. 8):

(HV[i, j], DN[i, i])=(0, 0) and (HV[i+2, j], DN[i+2, j])=(0, 0) Conditions-1

If the conditions-1 are satisfied, the image processor 11 calculates G′[i+1, j] according to Equation (49) as a result of smoothing processing on the pixel (i.e., the pixel having the coordinates [i+1, j]) and located immediately on the right of the pixel for which the interpolated value has been calculated (step S5 in FIG. 8):

G′[i+1, j]=(k1·G[i, j−1]+k2·G[i+1, j]+k3·G[i, j+1])/(k1+k2+k3) (49)

That is, the image processor 11 sets a value that is calculated according to Equation (49) as a result of the smoothing processing only for a pixel that is interposed between pixels that are immediately on its left and on its right and in each of which the similarity in the vertical direction and that in the horizontal direction have no substantial difference.

Then, the image processor 11 judges whether the values of the indices HV[i, j] and DV[i, j] indicating the vertical and horizontal similarity and the diagonal similarity, respectively, of the pixel having the coordinates [i, j] and the values of the indices HV[i, j+2] and DV[i, j+2] indicating vertical and horizontal similarity and diagonal similarity, respectively, of the pixel having the coordinates [i, j+2] satisfy the following conditions-2 (step S6 in FIG. 8):

(HV[i, j], DN[i, j])=(0, 0) and (HV[i, j+2], DN[i, j+2])=(0, 0) Conditions-2

If the conditions-2 are satisfied, the image processor 11 calculates G′[i, j+1] according to Equation (50) as a result of smoothing processing on the pixel (i.e., the pixel having the coordinates [i, j+1]) and located immediately over the pixel for which the interpolated value has been calculated (step S7 in FIG. 8):

G′[i, j+1]=(k4·G[i−1, j]+k5·G[i, j+1]+k6·G[i+1, j])/(k4+k5+k6) (50)

That is, the image processor 11 sets a value that is calculated according to Equation (50) as a result of the smoothing processing only for a pixel that is interposed between pixels that are immediately over and under it and in each of which the similarity in the vertical direction and that in the horizontal direction have no substantial difference.

Then, the image processor 11 judges whether the coordinates of every pixel to be subjected to the G interpolation processing have been set in [i, j] (step S8 in FIG. 8). If there remains a pixel(s) to be subjected to the G interpolation processing whose coordinates have not been set in [i, j], the image processor 11 again executes step S2 and the following steps.

With the above processing, in the second embodiment, green interpolated values and values indicating results of the smoothing processing are set in G′[i, j]'s.

As described above, in the second embodiment, a value obtained by performing weighted addition on pieces of color information on green color component in a local area is set as a value indicating a result of the smoothing processing only for pixels each of which are interposed between pixels in each of which the similarity in the vertical direction and that in the horizontal direction have no substantial difference among pixels that have color information on green color component.

Therefore, in the second embodiment, as in the case of the first embodiment, the pieces of color information in a flat area, an area of an isolated luminescent spot, or an area having a high-density checkerboard pattern are smoothed and hence the smoothing does not impair structures inherent in an image.

In the second embodiment, a value calculated according to Equation (49) or (50) is set as a result of the smoothing processing only for pixels each of which are interposed between pixels in each of which the similarity in the vertical direction and that in the horizontal direction have no substantial difference. Therefore, step S6 in FIG. 3 of the first embodiment for restoring G′[i, j−1] and G′[i−1,j] to the original pieces of color information on green color component is not necessary.

In the second embodiment, G′[i+1, j] is calculated according to Equation (49) when the conditions-1 are satisfied and G′[i, j+1] is calculated according to Equation (50) when the conditions-2 are satisfied. Alternatively, G′[i+1, j] and G′[i, j+1] may be calculated according to Equations (49) and (50), respectively, when the following conditions-3 are satisfied:

(HV[i, j], DN[i, j])=(0, 0) and (HV[i+1, j+1], DN[i+1, j+1])=(0, 0) Conditions-3

In each of the above embodiments, whether to perform the operation of Equation (49) or (50) is judged by using an index (or indices) HV indicating vertical and horizontal similarity and an index (or indices) DN indicating diagonal similarity that were set before a green interpolated value is calculated (step S4 in FIG. 3 and steps S4 and S6 in FIG. 8). Alternatively, indices to be used in making the above judgment may be set again in a state that a green interpolated value has been calculated.

In each of the above embodiments, whether to perform the operation of Equation (49) or (50) is judged by using an index (or indices) HV indicating vertical and horizontal similarity and an index (or indices) DN indicating diagonal similarity (step S4 in FIG. 3 and steps S4 and S6 in FIG. 8). Alternatively, the above judgment may be made by using only an index (or indices) HV indicating vertical and horizontal similarity.

Embodiment 3

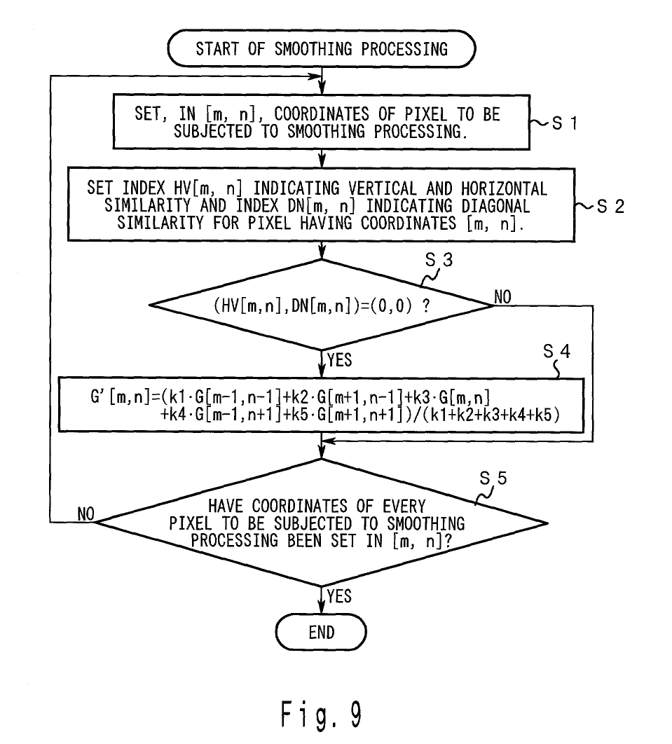

FIG. 9 is a flowchart showing part of the operation of the image processor 11 according to a third embodiment, specifically, smoothing processing.

In the third embodiment, the smoothing processing is applied to an image that has already been subjected to interpolation processing and hence has color information on green color component for all pixels. However, the smoothing processing according to the third embodiment can also be applied to an image having luminance values obtained through calorimetric system conversion.

The smoothing processing according to the third embodiment may be performed on either all pixels of an image or only pixels having color information on green color component originally like a pixel having coordinates [i, j−1] (as in the first and second embodiments).

The operation of the third embodiment will be described below. In the following, the smoothing processing of the image processor 11 will be described with reference to FIG. 9 and the other part of the operation will not be described. The third embodiment corresponds to claims 1-4, 12, and 13.

First, the image processor 11 sets, in [m, n], the coordinates of a pixel as a subject of the smoothing processing (step S1 in FIG. 9).

Step S1 in FIG. 9 is executed repeatedly. It is assumed that during the repetition the coordinates of pixels to be subjected to the smoothing processing among the pixels from the one located at the top-left corner of an image to the one located at its bottom-right corner are sequentially set in [m, n].

Then, the image processor 11 calculates similarity degrees in the vertical direction and the horizontal direction for the pixel having the coordinates [m, n] and sets an index HV[m, n] indicating vertical and horizontal similarity. Further, the image processor 11 calculates similarity degrees in the diagonal directions and sets an index DV[m, n] indicating diagonal similarity (step S2 in FIG. 9).

For example, the image processor 11 calculates a similarity degree Cv[m, n] in the vertical direction, a similarity degree Ch[m, n] in the horizontal direction, a similarity degree C45[m, n] in the diagonal 45° direction, and a similarity degree C135[m, n] in the diagonal 135° direction for the pixel having the coordinates [m, n] according to the following equations:

$$\begin{matrix}\begin{matrix}Cv [ m , n ] = \vert G [ m , n ] - G [ m , n - 1 ] \vert + \vert G [ m , n ] - G [ m , n + 1 \vert + \\ \vert G [ m - 1 , n ] - G [ m - 1 , n - 1 ] \vert + \vert G [ m - 1 , n ] - \\ G [ m - 1 , n + 1 ] \vert + \\ \vert G [ m + 1 , n ] - G [ m + 1 , n - 1 ] \vert + \vert G [ m + 1 , n ] - \\ G [ m + 1 , n + 1 ] \vert\end{matrix} & ( 53 ) \\ \begin{matrix}Ch [ m , n ] = \vert G [ m , n ] - G [ m - 1 , n ] \vert + \vert G [ m , n ] - G [ m + 1 , n \vert + \\ \vert G [ m , n - 1 ] - G [ m - 1 , n - 1 ] \vert + \vert G [ m , n - 1 ] - \\ G [ m + 1 , n - 1 ] \vert + \\ \vert G [ m , n + 1 ] - G [ m - 1 , n + 1 ] \vert + \vert G [ m , n + 1 ] - \\ G [ m + 1 , n + 1 ] \vert\end{matrix} & ( 54 ) \\ \begin{matrix}C45 [ m , n ] = \vert G [ m , n ] - G [ m - 1 , n + 1 ] \vert + \vert G [ m , n ] - G [ m + 1 , \\ n - 1 \vert + \\ \vert G [ m - 1 , n ] - G [ m , n - 1 ] \vert + \vert G [ m , n + 1 ] - \\ G [ m + 1 , n \vert\end{matrix} & ( 55 ) \\ \begin{matrix}C135 [ m , n ] = \vert G [ m , n ] - G [ m - 1 , n - 1 ] \vert + \vert G [ m , n ] - \\ G [ m + 1 , n + 1 \vert + \\ \vert G [ m - 1 , n ] - G [ m , n + 1 ] \vert + \vert G [ m , n - 1 ] - \\ G [ m + 1 , n \vert\end{matrix} & ( 56 )\end{matrix}$$

If a condition

|Cv[m, n]−Ch[m, n]|≦T1

is satisfied for an arbitrary threshold value Th1, the image processor 11 sets “0” in the index HV[m, n] with a judgment that the similarity in the vertical direction and that in the horizontal direction have no substantial difference. If conditions

|Cv[m, n]−Ch[m, n]|>Th1, and Cv[m, n]≧Ch[m, n]

are satisfied, the image processor 11 sets “−1” in the index HV[m, n] with a judgment that the similarity in the vertical direction is higher than in the horizontal direction. If conditions

|Cv[m, n]−Ch[m, n]|>Th1, and Cv[m, n]≧Ch[m, n]

are satisfied, the image processor 11 sets “−1” in the index HV[m, n] with a judgment that the similarity in the horizontal direction is higher than in the vertical direction.

Further, when a condition

|C45[m, n]−C135[m, n]|≧Th2

is satisfied for an arbitrary threshold value Th2, the image processor 11 sets “0” in the index DN[m, n] with a judgment that the degrees of similarity in the diagonal directions have no substantial difference. If conditions

|C45[m, n]−C135[m, n]|>Th2, and C45[m, n]<C135[m, n]

are satisfied, the image processor 11 sets “1”, in the index DN[m, n] with a judgment that the similarity in the diagonal 45° direction is higher than in the diagonal 135° direction. If conditions

|C45[m, n]−C135[m, n]|>Th2, and C45[m, n]≧C135[m, n]

are satisfied, the image processor 11 sets “−1” in the index DN[m, n] with a judgment that the similarity in the diagonal 135° direction is higher than in the diagonal 45° direction.

After setting the index HV[m, n] indicating vertical and horizontal similarity and the index DN[m, n] indicating diagonal similarity in the above-described manner, the image processor 11 judges whether both of the values of the indices HV[m, n] and DN[m, n] are 0 (step S3 in FIG. 9).

If both of the values of the indices HV[m, n] and DN[m, n] are 0, the image processor 11 calculates G′[m, n] as a result of smoothing processing on the pixel having the coordinates [m, n] according to the following Equation (57) (step S4 in FIG. 9):

$$\begin{matrix}{G}^{′} [ m , n ] = ( k1 \cdot G [ m - 1 , n - 1 ] + k2 \cdot G [ m + 1 , n - 1 ] + k3 \cdot \\ G [ m , n ] + k4 \cdot G [ m - 1 , n + 1 ] + \\ k5 \cdot G [ m + 1 , n + 1 ] ) / ( k1 + k2 + k3 + k4 + k5 )\end{matrix} \qquad ( 57 )$$

That is, the operation of Equation (57) corresponds to replacing the color information on green color component of the pixel having the coordinates [m, n] with a value obtained by performing weighted addition on the pieces of color information on green color component of the pixels having the coordinates [m−1, n−1], [m+1, n−1], [m, n], [m−1, n+1], and [m+1, n+1].

In Equation (57), the degree of smoothing can be changed by changing the values of k1-k5. For example, setting the values of k1-k5 in such a manner that k1=k2=k4=k5=1 and k3=4 means complete smoothing. To decrease the degree of smoothing, the values of k1-k5 may be set in such a manner that k1=k2=k4=k5=1 and k3=12.

The parameter G′[m, n] may be calculated according to the following Equation (57′) instead of Equation (57):

G′[m, n]=(k1·G[m−1, n−1]+k2·G[m+1, n−1]+k3·G[m, n])/(k1+k2+k3) (57′)

In Equation (57′), the ratio among k1, k2, and k3 may be set in such a manner that k1:k2:k3=1:2:1 or 1:6:1, for example.

Incidentally, in each of the first and second embodiments, G′[i+1, j] that is calculated as a result of the smoothing processing may be calculated by performing weighted addition on not only the pieces of color information on green color component of the pixels having the coordinates [i, j−1], [i+1, j], and [i, j+1] but also the pieces of color information on green color component of the pixels having the coordinates [i+2, j−1] and [i+2, j+1]. Similarly, G′[i, j+1] may be calculated by performing weighted addition on not only the pieces of color information on green color component of the pixels having the coordinates [i−1, j], [i, j+1], and [i+1, j] but also the pieces of color information on green color component of the pixels having the coordinates [i−1, j+2] and [i+1, j+2].

That is, in the invention, a pixel as a subject of smoothing processing is smoothed by using the color information on green color component of the target pixel itself and the pieces of color information on green color component of the pixels that are adjacent to the target pixel and are located in the diagonal directions.

Then, the image processor 11 judges whether the coordinates of every pixel to be subjected to the smoothing processing have been set in [m, n] (step S5 in FIG. 9). If there remains a pixel(s) to be subjected to the smoothing processing whose coordinates have not been set in [m, j], the image processor 11 again executes step S1 and the following steps.

With the above processing, in the third embodiment, values indicating results of the smoothing processing are set in G′[m, n]'s.

As described above, in the third embodiment, a value obtained by performing weighted addition on pieces of color information on green color component in a local area is set as a value indicating a result of the smoothing processing for only pixels in which the similarity in the vertical direction and that in the horizontal direction have no substantial difference and the degrees of similarity in the diagonal directions have no substantial difference. Therefore, the pieces of color information in a flat area, an area of an isolated luminescent spot, or an area having a high-density checkerboard pattern are smoothed and hence the smoothing does not impair structures inherent in an image.

In the third embodiment, whether to perform the operation of Equation (57) is judged by using an index HV indicating vertical and horizontal similarity and an index DN indicating diagonal similarity (step S3 in FIG. 9). Alternatively, the above judgment may be made by using only an index HV indicating vertical and horizontal similarity.

Embodiment 4

A fourth embodiment will be hereinafter described.

The fourth embodiment corresponds to a case that image processing is performed by the PC 18 shown in FIG. 1 by using a storage medium in which an image processing program as recited in any of claims 14-16 is stored.

It is assumed that an image processing program (for performing interpolation processing and smoothing processing in the same manner as the image processor 11 according to each of the above embodiments does) stored in a storage medium such as the CD-ROM 28 is installed in the PC 18 in advance. That is, such an image processing program is stored in the hard disk (not shown) in the PC 18 in such a manner as to be executable by the CPU (not shown).

The operation of the fourth embodiment will be described below with reference to FIG. 1.

When an operator selects a shooting mode and depresses the release button by manipulating the operation part 24, the electronic camera 1 digitizes, with the A/D converter 10, an image signal that has been generated by the image-capturing sensor 21 and subjected to prescribed analog signal processing in the analog signal processor 22, and supplies resulting image data to the image processor 11. The image processor 11 performs, on the received image data, image processing excluding the interpolation processing and the smoothing processing (e.g., γ correction and edge enhancement). The image data that has been subjected to the image processing is written to the memory card 16 via the memory card interface 17.

If instructed by the PC 18 via the external interface 19 to transfer image data in a state that a PC communication mode has been selected by an operator through the operation part 24, the electronic camera 1 reads the image data corresponding to the instruction from the memory card 16 via the memory card interface 17. The electronic camera 1 supplies the read-out image data to the PC 18 via the external interface 19.

When the image data is supplied to the PC 18, the CPU (not shown) in the PC 18 executes the above-mentioned image processing program. The image data that has been subjected to the interpolation processing and the smoothing processing through execution of the image processing program may be written to the hard disk (not shown) after being compressed when necessary or may be supplied to the display 26 or the printer 27 after being converted into data according to a calorimetric system employed therein.

As described above, the fourth embodiment allows the PC 18 to perform the same image processing (interpolation processing and smoothing processing) as described in each of the above embodiments.

When the memory card 16 in which image data is stored in the above-described manner is mounted in the PC 18, the CPU (not shown) in the PC 18 may read the image data from the memory card 16 and execute the above-mentioned image processing program.

The CPU (not shown) in the PC 18 may execute the above-mentioned image processing program to process image data even when the image data has been subjected to the interpolation processing and the smoothing processing in the image processor 11 of the electronic camera 1 as long as the resolution of the image data has been decreased to ¼ by decimation to reduce the transmission data amount of a transfer to the PC 18.

The invention is not limited to the above embodiments and various modifications may be made without departing from the spirit and scope of the invention. Any improvement may be made in part or all of the components.

What is claimed is:

1. An image processing device for smoothing image data that is formed by a plurality of pixels and includes at least one color component, comprising:
smoothing means for selectively performing, for at least one color component of a target pixel, smoothing that uses pieces of color information of at least one color component of the target pixel and of pixels adjacent to the target pixel among a plurality of pixels that form the image data, the smoothing done in accordance with correlation between the target pixel and pixels in the vicinity of the target pixel.

2. An image processing device for smoothing image data that is formed by a plurality of pixels and includes at least one color component, comprising:
similarity degree calculating means for calculating similarity degrees indicating similarity between a target pixel and pixels in the vicinity of the target pixel among a plurality of pixels that form the image data;
classifying means for classifying pixels whose similarity degrees have been calculated by the similarity degree calculating means into one of a plurality of groups having different similarity degree features; and
smoothing means for selecting a pixel to be subjected to smoothing from among a pixel that has been classified into a particular group in the plurality of groups and pixels in the vicinity of the pixel that has been classified into the particular group, and for performing smoothing on color information of at least one color component of the selected pixel by using pieces of color information of at least one color component of the selected pixel and of pixels adjacent to the selected pixel.

3. The image processing device according to claim 2, wherein said smoothing means smoothes color information of a color component of a pixel adjacent to a pixel that has been classified into the particular group by the classifying means, and restores into its original state color information of a color component of a smoothed pixel among pixels adjacent to a pixel that has not been classified into the particular group by the classifying means.

4. The image processing device according to claim 3, wherein said smoothing means:
sequentially selects pixels that became subjects of classification by the classifying means;
smoothes color information of a color component of a pixel that is adjacent to not only a pixel selected at an arbitrary time point but also to a pixel that is not selected at the arbitrary time point when the selected pixel is classified into the particular group; and
restores into its original state color information of a color component of a smoothed pixel among pixels adjacent to the pixel selected at the arbitrary time point when the selected pixel is not classified into the particular group.

5. The image processing device according to claim 2, wherein said smoothing means smoothes color information of a color component of a pixel that is adjacent to a plurality of pixels that have been classified into the particular group by the classifying means.

6. The image processing device according to claim 2, wherein said smoothing means uses, as said particular group, a group having a feature that similarity degrees calculated in at least two different directions by the similarity degree calculating means are approximately the same.

7. The image processing device according to claim 6, wherein said smoothing means judges that similarity degrees in at least two different directions are approximately the same when a difference between similarity degrees calculated in the at least two different directions by the similarity degree calculating means is smaller than a prescribed threshold value.

8. An image processing device for smoothing image data that is formed by a plurality of pixels and includes at least one color component, comprising:
interpolating means for interpolating pieces of color information of a color component that is absent from pixels that are arranged at a prescribed pitch among pixels that form the image data;
similarity degree calculating means for calculating similarity degrees in at least two different directions for each pixel to be a subject of interpolation by the interpolating means;
classifying means for classifying each of pixels whose similarity degrees have been calculated by the similarity degree calculating means into one of a plurality of groups having different similarity degree features; and
smoothing means for selecting a pixel to be subjected to smoothing from among a pixel that has been classified into a particular group in the plurality of groups and pixels in the vicinity of the pixel that has been classified into the particular group, and for performing smoothing on color information of a color component of the selected pixel by using pieces of color information of color components of the selected pixel and of pixels adjacent to the selected pixel.

9. The image processing device according to claim 8, wherein: said smoothing means performs the smoothing parallel with the interpolation by the interpolating means.

10. The image processing device according to claim 8, wherein:
said interpolating means employs, as subjects of the interpolation, pixels that miss a color component having a highest spatial arrangement density; and
said smoothing means smoothes color information of the color component having the highest spatial arrangement density of a pixel adjacent to a pixel that has been classified into the particular group.

11. The image processing device according to claim 8, wherein said smoothing means smoothes color information of a color component of a pixel adjacent to a pixel that has been classified into the particular group by the classifying means, and restores into its original state color information of a color component of a smoothed pixel among pixels adjacent to a pixel that has not been classified into the particular group by the classifying means.

12. The image processing device according to claim 11, wherein said smoothing means:
sequentially selects pixels that became subjects of classification by the classifying means;
smoothes color information of a color component of a pixel that is adjacent to not only a pixel selected at an arbitrary time point but also to a pixel that is not selected at the arbitrary time point when the selected pixel is classified into the particular group; and
restores into its original state color information of a color component of a smoothed pixel among pixels adjacent to the pixel selected at the arbitrary time point when the selected pixel is not classified into the particular group.

13. The image processing device according to claim 8, wherein said smoothing means smoothes color information of a color component of a pixel that is adjacent to a plurality of pixels that have been classified into the particular group by the classifying means.

14. The image processing device according to claim 8, wherein said smoothing means uses, as said particular group, a group having a feature that similarity degrees calculated in at least two different directions by the similarity degree calculating means are approximately the same.

15. The image processing device according to claim 14, wherein said smoothing means judges that similarity degrees in at least two different directions are approximately the same when a difference between similarity degrees calculated in the at least two different directions by the similarity degree calculating means is smaller than a prescribed threshold value.

16. A storage medium in which an image processing program is stored that causes a computer to smooth image data that is formed by a plurality of pixels and includes at least one color component, the image processing program causing the computer to execute:
a smoothing step of selectively performing, for at least one color component of a target pixel, smoothing that uses pieces of color information of at least one color component of the target pixel and of pixels adjacent to the target pixel among a plurality of pixels that form the image data, the smoothing done in accordance with correlation between the target pixel and pixels in the vicinity of the target pixel.

17. A storage medium in which an image processing program is stored that causes a computer to smooth image data that is formed by a plurality of pixels and includes at least one color component, the image processing program causing the computer to execute:
a similarity degree calculating step of calculating similarity degrees indicating similarity between a target pixel and pixels in the vicinity of the target pixel among a plurality of pixels that form the image data;
a classifying step of classifying pixels whose similarity degrees have been calculated by the similarity degree calculating step into one of a plurality of groups having different similarity degree features; and
a smoothing step of selecting a pixel to be subjected to smoothing from among a pixel that has been classified into a particular group in the plurality of groups and pixels in the vicinity of the pixel that has been classified into the particular group, and for performing smoothing on color information of at least one color component of the selected pixel by using pieces of color information of at least one color component of the selected pixel and of pixels adjacent to the selected pixel.

18. The storage medium storing the image processing program according to claim 17, wherein said smoothing step smoothes color information of a color component of a pixel adjacent to a pixel that has been classified into the particular group by the classifying step, and restores into its original state color information of a color component of a smoothed pixel among pixels adjacent to a pixel that has not been classified into the particular group by the classifying step.

19. The storage medium storing the image processing program according to claim 18, wherein said smoothing step:
sequentially selects pixels that became subjects of classification by the classifying step;
smoothes color information of a color component of a pixel that is adjacent to not only a pixel selected at an arbitrary time point but also to a pixel that is not selected at the arbitrary time point when the selected pixel is classified into the particular group; and
restores into its original state color information of a color component of a smoothed pixel among pixels adjacent to the pixel selected at the arbitrary time point when the selected pixel is not classified into the particular group.

20. The storage medium storing the image processing program according to claim 17, wherein said smoothing step smoothes color information of a color component of a pixel that is adjacent to a plurality of pixels that have been classified into the particular group by the classifying step.

21. The storage medium storing the image processing program according to claim 17, wherein said smoothing step uses, as said particular group, a group having a feature that similarity degrees calculated in at least two different directions by the similarity degree calculating step are approximately the same.

22. The storage medium storing the image processing program according to claim 21, wherein said smoothing step judges that similarity degrees in at least two different directions are approximately the same when a difference between similarity degrees calculated in the at least two different directions by the similarity degree calculating step is smaller than a prescribed threshold value.

23. A storage medium in which an image processing program is stored that causes a computer to smooth image data that is formed by a plurality of pixels and includes at least one color component, the image processing program causing the computer to execute:
interpolating step for interpolating pieces of color information of a color component that is absent from pixels that are arranged at a prescribed pitch among pixels that form the image data;
similarity degree calculating step for calculating similarity degrees in at least two different directions for each pixel to be a subject of interpolation by the interpolating step;
classifying step for classifying each of pixels whose similarity degrees have been calculated by the similarity degree calculating step into one of a plurality of groups having different similarity degree features; and
smoothing step for selecting a pixel to be subjected to smoothing from among a pixel that has been classified into a particular group in the plurality of groups and pixels in the vicinity of the pixel that has been classified into the particular group, and for performing smoothing on color information of a color component of the selected pixel by using pieces of color information of color components of the selected pixel and of pixels adjacent to the selected pixel.

24. The storage medium storing the image processing program according to claim 23, wherein said smoothing step performs the smoothing parallel with the interpolation by the interpolating step.

25. The storage medium storing the image processing program according to claim 23, wherein:
said interpolating step employs, as subjects of the interpolation, pixels that miss a color component having a highest spatial arrangement density; and
said smoothing step smoothes color information of the color component having the highest spatial arrangement density of a pixel adjacent to a pixel that has been classified into the particular group.

26. The storage medium storing the image processing program according to claim 23, wherein said smoothing step smoothes color information of a color component of a pixel adjacent to a pixel that has been classified into the particular group by the classifying step, and restores into its original state color information of a color component of a smoothed pixel among pixels adjacent to a pixel that has not been classified into the particular group by the classifying step.

27. The storage medium storing the image processing program according to claim 26, wherein said smoothing step:
sequentially selects pixels that became subjects of classification by the classifying step;
smoothes color information of a color component of a pixel that is adjacent to not only a pixel selected at an arbitrary time point but also to a pixel that is not selected at the arbitrary time point when the selected pixel is classified into the particular group; and
restores into its original state color information of a color component of a smoothed pixel among pixels adjacent to the pixel selected at the arbitrary time point when the selected pixel is not classified into the particular group.

28. The storage medium storing the image processing program according to claim 23, wherein said smoothing step smoothes color information of a color component of a pixel that is adjacent to a plurality of pixels that have been classified into the particular group by the classifying step.

29. The storage medium storing the image processing program according to claim 23, wherein said smoothing step uses, as said particular group, a group having a feature that similarity degrees calculated in at least two different directions by the similarity degree calculating step are approximately the same.

30. The storage medium storing the image processing program according to claim 29, wherein said smoothing step judges that similarity degrees in at least two different directions are approximately the same when a difference between similarity degrees calculated in the at least two different directions by the similarity degree calculating step is smaller than a prescribed threshold value.
